(19) United States
(12) Patent Application Publication
(10) Pub. No.: US 2011/0211694 A1
(43) Pub. Date: Sep. 1, 2011

(54) DISABLING A CLEARTEXT CONTROL WORD LOADING MECHANISM IN A CONDITIONAL ACCESS SYSTEM

(75) Inventor: Antonius Johannes Petrus Maria Van De Ven, Schiedam (NL)

(73) Assignee: Irdeto Corporate B.V., Hoofddorp (NL)

(21) Appl. No.: 13/034,980

(22) Filed: Feb. 25, 2011

(30) Foreign Application Priority Data
Feb. 25, 2010 (EP) 10154690.1

(51) Int. Cl. H04N 7/167

(52) U.S. Cl. 380/211

(57) ABSTRACT

Various embodiments enable a chipset of a receiver of a conditional access system to block cleartext control words provided to the chipset from being used to descramble content. Hereto the chipset comprises a trigger module configured to obtain a disable command that is received with an encrypted Chip Set Session Key (CSSK) and, if the disable command is obtained, have the chipset block any cleartext control word.

### CLAIM OF PRIORITY

The present patent application claims the benefit of priority under 35 U.S.C. §119 to European Patent Application No. 10154690.1, filed Feb. 25, 2010, the entire contents of which is incorporated herein by reference in its entirety.

### FIELD OF THE INVENTION

The present invention relates to a chipset for obtaining a control word to descramble content in a content descrambler, a method for use in the chipset, a secure device for use in a conditional access system, a head-end system, a method for use in the head-end system and a conditional access system.

### BACKGROUND

Conditional access systems for digital video broadcast (DVB) transmissions are well known and widely used in conjunction with pay television services. Such systems provide secure transmission of a broadcast stream comprising one or more services to a digital receiver contained for example in a set-top box or a mobile terminal supporting broadcast services. To protect the broadcast services from unauthorized viewing, the data packets are scrambled (encrypted) at the transmitter side with an encryption key commonly referred to as a control word. Further security is provided by periodically changing the control words so they are only valid for a certain period. Typically control words are transmitted in encrypted form to the receiver using so-called entitlement control messages (ECMs).

In the receiver an ECM is filtered out of a transport stream and sent to a secure computing environment, e.g. a smartcard. The smartcard subsequently decrypts the ECM using a higher-level key, which is common to all smartcards that are authorised to receive the TV channels associated with that key. The control word is returned to the receiver, which immediately loads the control word into the descrambler for descrambling data.

The transmission of control words from the smartcard to the receiver is vulnerable to interception of the control word on the interface between the smartcard and the receiver. Control word piracy is a significant problem in digital video broadcasting (DVB) systems. Sometimes attackers are able to intercept a control word that is transmitted from the smartcard to the receiver and redistribute it over local networks or over the internet. The redistributed control word is then used to descramble the scrambled services without a legitimate smartcard. In order to complicate control word piracy, it is known that the smartcard and receiver use a chipset session key CSSK for encrypting the stream of control words on the interface between the smartcard and the receiver.

The smartcard is pre-provisioned with a unique serial number and a unique key and the chipset of the receiver is also pre-provisioned with a chip set serial number CSSN. Moreover, a chip set unique key CSUK is stored in a secured portion of the receiver, and CSSN and CSUK are linked. CSSN and CSUK cannot be changed after being provisioned in the receiver. Key CSUK is not stored in the smartcard.

FIG. 1 shows a prior art example of a chipset 1 of a receiver to load keys to descramble content. Decryptors 10a, 10b and 10c use encrypted input data and an input key to obtain decrypted output data. Elements 11 and 12 are read-only memory locations. Elements 13 and 14 are read-and-write memory locations for temporary storing decrypted output data. Content decoder 15 decodes the descrambled content. The secure chipset 1 further comprises a Disable Clear CW Loading (DCCL) module 16 and a blocking module 17. Dataflows between elements are indicated by arrows. Dataflows are identified by labels along the arrows.

In the example of FIG. 1, a content stream scrambled with a control word CW, denoted by {Content}_{CW}, is received in the secure chipset 1. The chipset 1 supports secure loading of the associated CW using input {CW}_{CSSK}, which denotes the CW encrypted with a Chip Set Session Key ‘CSSK’. The CSSK may be securely received encrypted with a Chip Set Unique Key ‘CSUK’, which is denoted by input {CSSK}_{CSUK}. The CSUK and a Chip Set Serial Number ‘CSSN’ are typically pre-installed in memory location 12 and memory location 11, respectively, and cannot be altered. The CSSN is typically available to software executing in the receiver for identification purposes. The CSUK is typically secured, such that is can only be used in the secure chipset to decrypt the CSSK from {CSSK}_{CSUK}.

The content decoder 15 can be external to the chipset 1 and is typically a part of the receiver.

Known conditional access systems use a key loading mechanism, such as shown in FIG. 1, by sending an entitlement management message ‘EMM’ and entitlement control messages ‘ECM’ from a head-end system to the smartcard. The EMM contains the CSSK and its encrypted version {CSSK}_{CSUK}. The ECM contains the encrypted CW. The smartcard provides {CSSK}_{CSUK} to the receiver and uses the CSSK as a session key for loading a sequence of CWs.

Chipsets such as shown in FIG. 1 support loading of cleartext (i.e. unencrypted) CWs into the descrambling part of the chipset or receiver. In FIG. 1 this is depicted by input CW, which is provided to the blocking module 17. To avoid the cleartext CW from being used, a disable command is input to the DCCL module 16. If the CW is to be blocked from use, the DCCL module 16 provides a disable instruction to the blocking module 17 to block the CW from being provided to the content decryptor 10c.

Disadvantageously, the possibility of loading cleartext CWs enables bypassing of the secure loading of {CW}_{CSSK}. If, e.g., an attacker finds a way to obtain the cleartext CW, the cleartext CW can be loaded into chipsets or receivers using the cleartext CW loading mechanism. Moreover, the attacker may be able to block the disable command, thus retaining the possibility to load cleartext CWs.

There is a need for an improved solution for selectively and permanently disabling the use of cleartext CWs that are input to a chipset of a receiver from being used to descramble scrambled content.

### SUMMARY OF THE INVENTION

It is an object of the invention to enable substantially unblockable and selective disablement of cleartext control words that are input to a chipset of a receiver from being used to descramble scrambled content.

According to an aspect of the invention a chipset is proposed for obtaining a control word to descramble scrambled content in a content descrambler. The chipset comprises one or more inputs for receiving a cleartext control word, a first disable instruction, an encrypted Chip Set Session Key (hereinafter “CSSK”) and an encrypted first control word. The chipset further comprises a first memory configured to store a Chip Set Unique Key (hereinafter “CSUK”). The chipset further comprises a first decryptor configured to decrypt the encrypted CSSK using the CSUK from the first memory. The chipset is configured to store the obtained CSSK in a second memory. The chipset further comprises a second decryptor configured to decrypt the encrypted first control word using the CSSK from the second memory. The chipset is configured to store the obtained first control word in a third memory for use by the content descrambler. The chipset further comprises a blocking module configured to conditionally store the cleartext control word in the third memory for use by the content descrambler. The blocking module is further configured to block the cleartext control word from being stored in the third memory if the first disable instruction is received. The chipset further comprises a trigger module configured to obtain a disable command that is received with the encrypted CSSK and, if the disable command is obtained, provide the disable command to the blocking module. The blocking module is further configured to block any cleartext control word from being stored in the third memory if the disable command is received.

According to an aspect of the invention a method is proposed for blocking a cleartext control word from being used to descramble scrambled content in a content descrambler. The method comprises receiving an encrypted Chip Set Session Key (hereinafter “CSSK”) and an encrypted first control word. The method further comprises decrypting the encrypted CSSK using a Chip Set Unique Key (hereinafter “CSUK”) stored in a first memory and storing the obtained CSSK in a second memory. The method further comprises decrypting the encrypted first control word using the CSSK from the second memory and storing the obtained first control word in a third memory for use by the content descrambler. The method further comprises obtaining a disable command that is received with the encrypted CSSK. The method further comprises, if the disable command is obtained, blocking any cleartext control word received in the chipset from being stored in the third memory for use by the content descrambler.

In prior art chipsets the first disable instruction could be blocked to disable blocking of cleartext control words. Typically the first disable instruction is blocked for a particular content stream to allow pirated CWs for that stream to be used in the chipset.

The invention enables a disable command to block the cleartext control word from being used. The disable command is provided to the chipset with the encrypted CSSK. The encrypted CSSK is typically not blocked to enable the chipset to decrypt encrypted CWs for legitimately descrambling content using the decrypted CWs.

When the disable command is received, the cleartext loading mechanism of the chipset is disabled.

A content provider may choose not to disable the cleartext loading mechanism. The head-end system in the conditional access system must then be configured never to provide the disable command with the encrypted CSSK. In this scenario the cleartext control words can be used together with first disable instructions as in the prior art.

The embodiments of claims 2 and 11 advantageously enable the disable command to be provided in encrypted form together with the encrypted CSSK.

The embodiments of claims 3 and 12 advantageously enable the disable command to be provided without changing external hardware and/or software interfaces of the chipset.

The embodiments of claims 4 and 13 advantageously enable the disable command to be provided without changing external hardware and/or software interfaces of the chipset and with minimal changes in existing (prior art) elements of the chipset.

The embodiment of claim 5 advantageously enables the disable command and the disable instruction to the blocking module to be in different formats.

According to an aspect of the invention a receiver is proposed for use in a conditional access system. The receiver comprises the chipset having one or more of the above features.

According to an aspect of the invention a head-end system is proposed for use in a conditional access system and for provisioning of a CSSK and an encrypted CSSK to the chipset having one or more of the above features. The head-end system comprises a processor configured to generate a CSSK such that the disable command is obtained in the trigger function of the trigger module when using the CSSK as input. The head-end system further comprises a memory configured to store one or more CSUKs of one or more chipsets. The head-end system further comprises an encryptor configured to encrypt the CSSK using the CSUK of the secure chipset from the memory to obtain the encrypted CSSK. The head-end system further comprises a transmitter configured to transmit the CSSK and the encrypted CSSK to the chipset via the intermediary of a secure device.

According to an aspect of the invention a method is proposed for use in a head-end system and for provisioning of a CSSK and an encrypted CSSK to the secure chipset having one or more of the above features. The method comprises generating a CSSK such that the disable command is obtained in the trigger function of the trigger module when using the CSSK as input. The method further comprises encrypting the CSSK using a CSUK of the secure chipset to obtain the encrypted CSSK. The method further comprises transmitting the CSSK and the encrypted CSSK to the secure chipset via the intermediary of a secure device.

Thus, the head-end system can provide a disable command to the chipset without requiring external hardware and/or software interfaces of the chipset to be changed.

According to an aspect of the invention a head-end system is proposed for use in a conditional access system and for provisioning of a CSSK and an encrypted CSSK to the chipset having one or more of the above features. The head-end system comprises a processor configured to generate the encrypted CSSK such that the disable command is obtained in the trigger function of the trigger module when using the encrypted CSSK as input. The head-end system further comprises a memory configured to store one or more CSUKs of one or more chipsets. The head-end system further comprises a decryptor configured to decrypt the encrypted CSSK using the CSUK of the secure chipset from the memory to obtain a CSSK. The head-end system further comprises a transmitter configured to transmit the CSSK and the encrypted CSSK to the chipset via the intermediary of a secure device.

According to an aspect of the invention a method is proposed for use in a head-end system and for provisioning of a CSSK and an encrypted CSSK to the secure chipset having one or more of the above features. The method comprises generating the encrypted CSSK such that the disable command is obtained in the trigger function of the trigger module when using the encrypted CSSK as input. The method further comprises decrypting the encrypted CSSK using a CSUK of the secure chipset to obtain a CSSK. The method further comprises transmitting the CSSK and the encrypted CSSK to the secure chipset via the intermediary of a secure device.

Thus, the head-end system can provide a disable command to the chipset without requiring external hardware and/or software interfaces of the chipset to be changed and with minimal changes in existing (prior art) elements of the chipset.

The CSSK and the encrypted CSSK are typically transmitted from the head-end system to a secure device comprising the chipset in an entitlement management message and through the intermediary of a receiver. The encrypted control word is typically transmitted in an entitlement control message to the secure device.

According to an aspect of the invention a conditional access system is proposed comprising the receiver having one or more of the above features and the head-end system having one or more of the above features.

Hereinafter, embodiments of the invention will be described in further detail. It should be appreciated, however, that these embodiments may not be construed as limiting the scope of protection for the present invention.

### BRIEF DESCRIPTION OF THE DRAWINGS

Aspects of the invention will be explained in greater detail by reference to exemplary embodiments shown in the drawings, in which:

FIG. 1 shows a prior art chipset;

FIG. 2 shows a chipset of an exemplary embodiment of the invention;

FIG. 3 shows a chipset of another exemplary embodiment of the invention;

FIG. 4 shows a chipset of another exemplary embodiment of the invention;

FIG. 5 shows a conditional access system of an exemplary embodiment of the invention;

FIG. 6 shows a method for use in a chipset of an exemplary embodiment of the invention;

FIG. 7 shows a method for use in a chipset of another exemplary embodiment of the invention;

FIG. 8 shows a method for use in a chipset of another exemplary embodiment of the invention;

FIG. 9 shows a method for use in a head-end system of an exemplary embodiment of the invention; and

FIG. 10 shows a method for use in a head-end system of another exemplary embodiment of the invention.

### DETAILED DESCRIPTION OF THE DRAWINGS

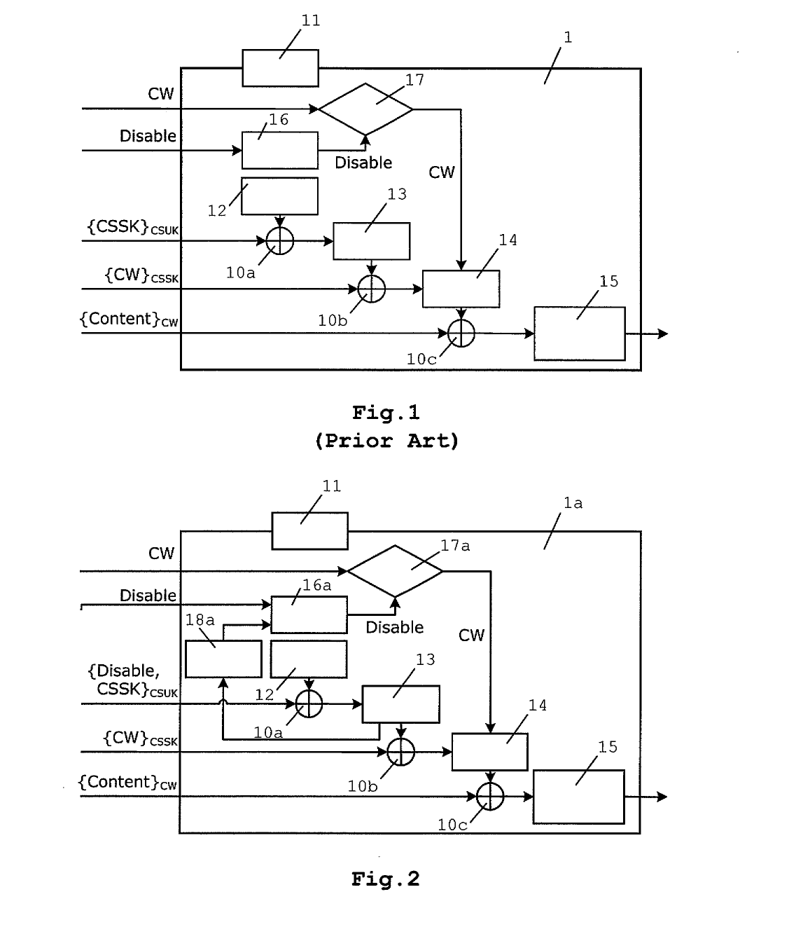

Operators of a conditional access system may want to use the cleartext CW mechanism in receivers. It is therefore desirable to have the possibility to choose whether or not the disabling of the cleartext CW loading mechanism is triggered. Hereto the invention enables selectively disabling of the cleartext CW loading mechanism, i.e. as long as the cleartext CW loading mechanism has not been disabled, loading of a cleartext CW and use of a disable command as shown in FIG. 1 remains possible.

The invention enables a chipset in a receiver of a conditional access system to block cleartext control words provided to the chipset from being used to descramble content. Hereto the chip set comprises a trigger module configured to obtain a disable command that is received with an encrypted Chip Set Session Key (CSSK) and, if the disable command is obtained, have the chipset block any cleartext control word.

FIG. 2 shows an exemplary embodiment of the invention, wherein chipset 1a is an improvement of the chipset 1 shown in FIG. 1. Decryptors 10b and 10c, read-only memory locations 11 and 12, read-and-write memory locations 13 and 14 and content decoder 15 are similar to the elements shown in FIG. 1. The content decoder 15 can be external to the chipset 1 and is typically a part of the receiver.

In the example of FIG. 2, a disable command is received together with the CSSK as input encrypted under CSUK, which is denoted by {Disable,CSSK}_{CSUK}. After decryption in decryptor 10a, the decrypted disable command and the decrypted CSSK are temporary stored in memory location 13.

Trigger module 18a looks for the disable command in memory location 13. If the disable command is found, the disable command is provided by the trigger module 18a to the DCCL module 16a and the DCCL module 16a provides a disable instruction to the blocking module 17a to permanently block any cleartext CW from being provided to the content decryptor 10c. Thus, the cleartext CW loading mechanism can be permanently disabled.

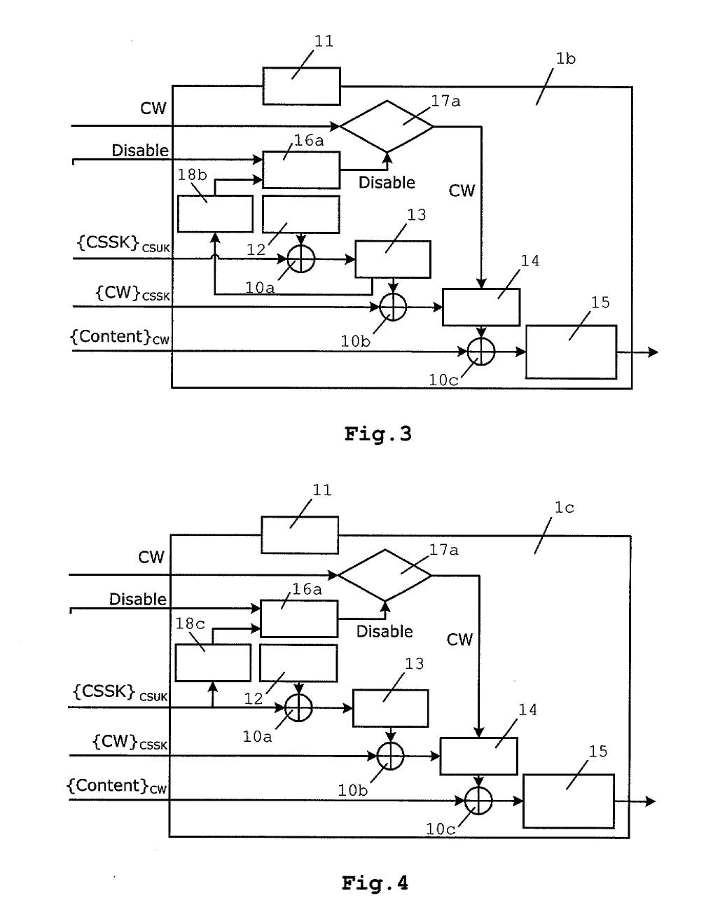

FIG. 3 shows an alternative embodiment of the invention, wherein chipset 1b is an alternative of the chipset 1a shown in FIG. 2. The CSSK is input encrypted under CSUK, which is denoted by {CSSK}_{CSLUK}. After decryption in decryptor 10a, the decrypted CSSK data is temporary stored in memory location 13. Trigger module 18b is configured to read the CSSK data from the memory location 13 and derive a disable command directly from the CSSK data.

Hereto the trigger module 18b is configured to execute a trigger function T to decide whether or not the CSSK data contains an implicit trigger for a disable command. Function T is e.g. a parity check with a binary output ‘0’ or ‘1’. The result of the evaluation T(CSSK)→{0,1} determines if the disable command is implied by the CSSK data.

If the presence of an implied disable command is detected, a disable command is provided by the trigger module 18b to the DCCL module 16a and the DCCL module 16a provides a disable instruction to the blocking module 17a to permanently block any cleartext CW from being provided to the content decryptor 10c.

FIG. 4 shows an alternative embodiment of the invention, wherein chipset lc is an alternative of the chipset 1b shown in FIG. 3. In the example of FIG. 4 the {CSSK}_{CSUK} is input to decryptor 10a and to trigger module 18c.

In the example of FIG. 4, the encrypted CSSK, i.e. {CSSK}_{CSUK}, forms the input to the trigger function T in trigger module 18c. The calculation of T({CSSK}CSUK)→{0,1} determines if the disable command is implied by the {CSSK}_{CSUK} input.

If the presence of an implied disable command is detected, a disable command is provided by the trigger module 18c to the DCCL module 16a and the DCCL module 16a provides a disable instruction to the blocking module 17a to permanently block any cleartext CW from being provided to the content decryptor 10c.

In the examples of FIG. 3 and FIG. 4 the trigger function T is a function with a binary output. As an example, a binary output ‘1’ indicates that the cleartext CW loading mechanism is to be disabled thus not allowing any cleartext CWs to be used. An example of a Boolean trigger function T is the determination of an occurrence of a certain bit value or bit pattern in the input parameter. Another example is the calculation of the parity of the input parameter. It is possible to extend the trigger function T to map its input parameter to a larger set of valid output values. In this case the trigger module 18b,18c is configured to compare the output of the trigger function T with preconfigured values and provide a disable command to the disable module 16a depending on the outcome of the comparison.

In the examples of FIG. 3 and FIG. 4 the range of useable values for the CSSK keys may be limited. If e.g. the trigger function T is a parity function, half of the possible input parameter range decodes to an implicit disable command. Thus only half of all possible input parameters can be used as CSSK or {CSSK}_{CSUK} in case the cleartext CW loading mechanism is to be disabled.

The disable command obtained by the trigger module 18a,18b,18c and the disable command provided from the trigger module 18a,18b,18c to the disable module 16a may be formatted differently. Alternatively, the trigger module 18a,18b,18c may forward the obtained disable command to the disable module 16a.

The disable instruction provided from the disable module 16a to the trigger module 17a may be identical to the disable command received in the disable module 16a from the trigger module 18a,18b,18c. Alternatively, the disable instruction and the disable command may be formatted differently.

The DCCL module 16a may be a temporary buffer memory for storing the disable command and forwarding the disable command as a disable instruction to the blocking module 17. Alternatively the DCCL module 16a converts the disable command into the disable instruction.

Modules may be combined. E.g. the blocking module 16a and the disable module 17a may be implemented as a single module. E.g. the decryptors 10a, 10b and/or 10c may be implemented as a single module.

In the examples of FIG. 3 and FIG. 4, a head-end system provides—through the intermediary of a receiver and a secure device—the {CSSK}_{CSUK} data comprising the implicit disable command to the chipset 1b,1c. To generate the {CSSK}_{CSUK} data comprising the implicit disable command, the head-end system selects a parameter, which may be random, that meets the intended behaviour for the trigger function T in the trigger module 18b,18c. In the example of FIG. 3, the parameter represents the CSSK and the head-end system generates the {CSSK}_{CSUK} data by encrypting the parameter with the CSUK key. In the example of FIG. 4 the parameter represents the {CSSK}_{CSUK} data and the head-end system calculates the value of CSSK by decrypting the parameter with the CSUK key.

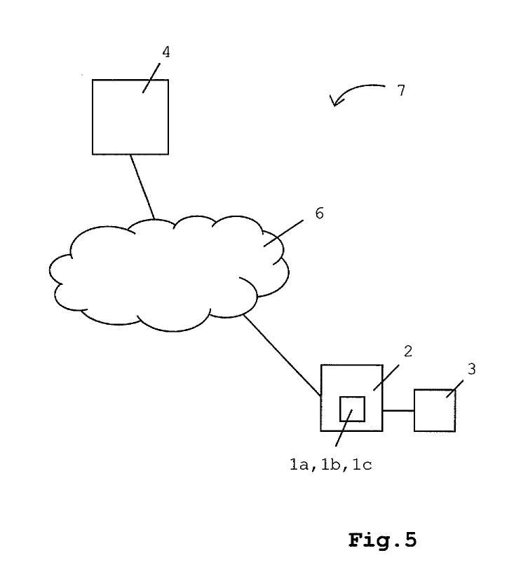

FIG. 5 shows a conditional access system 7 of an exemplary embodiment of the invention. A head-end system 4 transmits ECMs, EMMs and a content stream scrambled with a CW (i.e. {Content}_{CW}) to one or more receivers 2 via the distribution network 6. The ECM typically contains one or more encrypted CWs. The EMM typically contains the CSSK and its encrypted version {CSSK}_{CSUK}. The ECMs and EMMs are processed by a secure device 3 that is communicatively connected to the receiver 2. The secure device 3 is e.g. a smartcard and may be implemented in software running in a secured environment of the receiver 2. The smartcard 3 obtains the CW by processing the input from the ECM and obtains the CSKK and the {CSSK}_{CSUK} from the EMM. The smartcard sends the CSSK to the chipset 1a,1b,1c of the receiver 2. The smartcard 3 re-encrypts the CW with the CSSK key shared between the secure device 3 and the chipset 1a,1b,1c of receiver 2. The decryption module 10b decrypts the CW before providing it to the decryptor 10c.

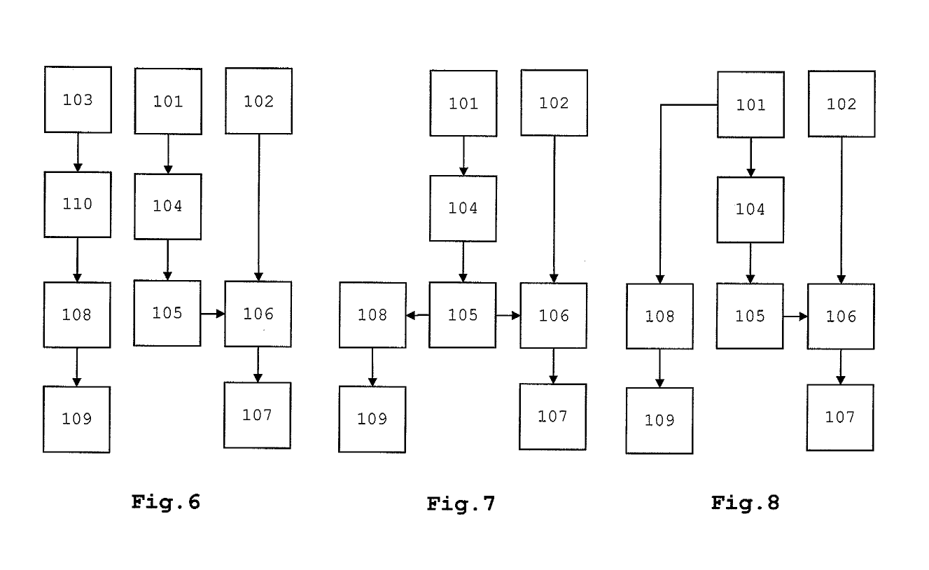

FIG. 6 shows a method for use in the chipset shown in FIG. 2. In step 101 the encrypted CSSK is received. In step 102 the encrypted first control word is received. The encrypted CSSK is decrypted in step 104 using the CSUK stored in the first memory 12. The obtained CSSK is stored in a second memory 13 in step 105. In step 106 the encrypted first control word is decrypted using the CSSK from the second memory 13. In step 107 the obtained first control word is stored in a third memory 14 for use by the content descrambler 10c. In step 103 the encrypted disable command is received. In step 110 the encrypted disable command is decrypted using the CSUK to obtain the disable command. In step 108 the disable command is obtained that is received with the encrypted CSSK. If the disable command is obtained, in step 109 any cleartext control word received in the chipset 1a,1b,1c is blocked from being stored in the third memory for use by the content descrambler 10c.

FIG. 7 shows a method for use in the chipset shown in FIG. 3. In step 101 the encrypted CSSK is received. In step 102 the encrypted first control word is received. The encrypted CSSK is decrypted in step 104 using the CSUK stored in the first memory 12. The obtained CSSK is stored in a second memory 13 in step 105. In step 106 the encrypted first control word is decrypted using the CSSK from the second memory 13. In step 107 the obtained first control word is stored in a third memory 14 for use by the content descrambler 10c. The disable command is obtained by processing the CSSK from the second memory 13 with a trigger function that uses the CSSK as input. In step 108 the disable command is obtained that is received with the encrypted CSSK. If the disable command is obtained, in step 109 any cleartext control word received in the chipset 1a,1b,1c is blocked from being stored in the third memory for use by the content descrambler 10c.

FIG. 8 shows a method for use in the chipset shown in FIG. 4. In step 101 the encrypted CSSK is received. In step 102 the encrypted first control word is received. The encrypted CSSK is decrypted in step 104 using the CSUK stored in the first memory 12. The obtained CSSK is stored in a second memory 13 in step 105. In step 106 the encrypted first control word is decrypted using the CSSK from the second memory 13. In step 107 the obtained first control word is stored in a third memory 14 for use by the content descrambler 10c. The disable command is obtained by processing the encrypted CSSK with a trigger function that uses the encrypted CSSK as input. In step 108 the disable command is obtained that is received with the encrypted CSSK. If the disable command is obtained, in step 109 any cleartext control word received in the chipset 1a,1b,1c is blocked from being stored in the third memory for use by the content descrambler 10c.

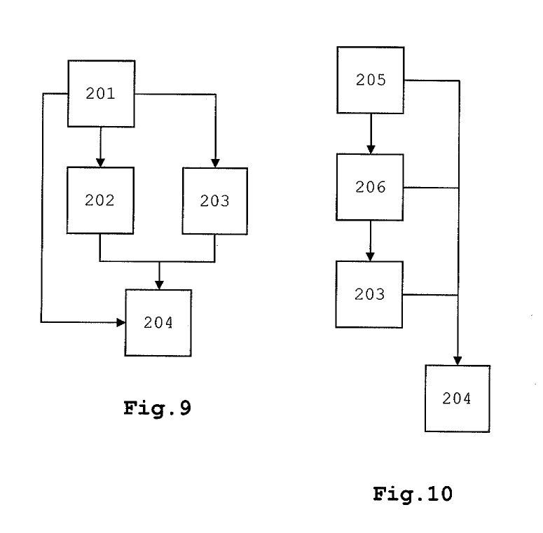

FIG. 9 shows a method for use in a head-end system 4. In step 201 a CSSK is generated such that the disable command is obtained in the trigger function of the trigger module 18b when using the CSSK as input. In step 202 the CSSK is encrypted using a CSUK of the secure chipset 1b to obtain the encrypted CSSK, The CSSK and the encrypted CSSK are transmitted in step 204 to the secure chipset 1b via the intermediary of a secure device 3.

FIG. 10 shows a method for use in another head-end system 4. In step 205 the encrypted CSSK is generated such that the disable command is obtained in the trigger function of the trigger module 18c when using the encrypted CSSK as input. In step 206 the encrypted CSSK is decrypted using a CSUK of the secure chip set (1b) to obtain a CSSK. The CSSK and the encrypted CSSK are transmitted in step 204 to the secure chipset 1c via the intermediary of a secure device 3.

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Moreover, the invention is not limited to the embodiments described above, which may be varied within the scope of the accompanying claims.

What is claimed is:

1. A chipset for obtaining a control word to descramble scrambled content in a content descrambler, the chipset comprising
one or more inputs for receiving a cleartext control word, a first disable instruction, an encrypted Chip Set Session Key (hereinafter “CSSK”) and an encrypted first control word;
a first memory configured to store a Chip Set Unique Key (hereinafter “CSUK”);
a first decryptor configured to decrypt the encrypted CSSK using the CSUK from the first memory, the chipset being configured to store the obtained CSSK in a second memory;
a second decryptor configured to decrypt the encrypted first control word using the CSSK from the second memory, the chipset further being configured to store the obtained first control word in a third memory for use by the content descrambler;
a blocking module configured to conditionally store the cleartext control word in the third memory for use by the content descrambler, the blocking module further configured to block the cleartext control word from being stored in the third memory if the first disable instruction is received; and
a trigger module configured to obtain a disable command that is received with the encrypted CSSK and, if the disable command is obtained, provide the disable command to the blocking module,
wherein the blocking module is further configured to block any cleartext control word from being stored in the third memory if the disable command is received.

2. The chip set according to claim 1, wherein the one or more inputs are further configured for receiving an encrypted disable command, wherein the first decryptor is further configured to decrypt the encrypted disable command using the CSUK, the chipset further being configured to store the obtained disable command in the first memory, and wherein the trigger module is configured to obtain the disable command from the first memory.

3. The chipset according to claim 1, wherein the trigger module is configured to obtain the CSSK from the first memory and configured with a trigger function that uses the CSSK as input to obtain the disable command.

4. The chipset according to claim 1, wherein the trigger module is configured with a trigger function that uses the encrypted CSSK as input to obtain the disable command.

5. The chipset according to claim 1, further comprising a Disable Clear CW Loading (hereinafter “DCCL”) module configured to receive the disable command from the trigger module and convert the disable command into a second disable instruction for use by the blocking module instead of the disable command.

6. A receiver for use in a conditional access system, the receiver comprising the chipset according to claim 1.

7. A head-end system for use in a conditional access system and for provisioning of a CSSK and an encrypted CSSK to the chipset according to claim 3, the head-end system comprising:
a processor configured to generate a CSSK such that the disable command is obtained in the trigger function of the trigger module when using the CSSK as input;
a memory configured to store one or more CSUKs of one or more chipsets;
an encryptor configured to encrypt the CSSK using the CSUK of the secure chipset from the memory to obtain the encrypted CSSK; and
a transmitter configured to transmit the CSSK and the encrypted CSSK to the chipset via the intermediary of a secure device.

8. A head-end system for use in a conditional access system and for provisioning of a CSSK and an encrypted CSSK to the chipset according to claim 4, the head-end system comprising:
a processor configured to generate the encrypted CSSK such that the disable command is obtained in the trigger function of the trigger module when using the encrypted CSSK as input;
a memory configured to store one or more CSUKs of one or more chipsets;
a decryptor configured to decrypt the encrypted CSSK using the CSUK of the secure chip set from the memory to obtain a CSSK; and
a transmitter configured to transmit the CSSK and the encrypted CSSK to the chipset via the intermediary of a secure device.

9. A conditional access system comprising the receiver according to claim 6 and the head-end system according to claim 7.

10. A method for use in a chipset for blocking a cleartext control word from being used to descramble scrambled content in a content descrambler, the method comprising:
receiving an encrypted Chip Set Session Key (hereinafter “CSSK”) and receiving an encrypted first control word;
decrypting the encrypted CSSK using a Chip Set Unique Key (hereinafter “CSUK”) stored in a first memory and storing the obtained CSSK in a second memory;
decrypting the encrypted first control word using the CSSK from the second memory and storing the obtained first control word in a third memory for use by the content descrambler;
obtaining a disable command that is received with the encrypted CSSK; and
if the disable command is obtained, blocking any cleartext control word received in the chipset from being stored in the third memory for use by the content descrambler.

11. The method according to claim 10, further comprising receiving an encrypted disable command and decrypting the encrypted disable command using the CSUK to obtain the disable command.

12. The method according to claim 10, wherein the disable command is obtained by processing the CSSK from the second memory with a trigger function that uses the CSSK as input.

13. The method according to claim 10, wherein the disable command is obtained by processing the encrypted CSSK with a trigger function that uses the encrypted CSSK as input.

14. A method for use in a head-end system and for provisioning of a CSSK and an encrypted CSSK to the secure chipset according to claim 3, the method comprising:
generating a CSSK such that the disable command is obtained in the trigger function of the trigger module when using the CSSK as input;
encrypting the CSSK using a CSUK of the secure chipset to obtain the encrypted CSSK; and
transmitting the CSSK and the encrypted CSSK to the secure chipset via the intermediary of a secure devic.

15. A method for use in a head-end system and for provisioning of a CSSK and an encrypted CSSK to the secure chipset according to claim 4, method comprising:
generating the encrypted CSSK such that the disable command is obtained in the trigger function of the trigger module when using the encrypted CSSK as input;
decrypting the encrypted CSSK using a CSUK of the secure chipset to obtain a CSSK; and
transmitting the CSSK and the encrypted CSSK to the secure chipset via the intermediary of a secure device.
